(19) United States
(12) Patent Application Publication
(10) Pub. No.: US 2018/0005747 A1
(43) Pub. Date: Jan. 4, 2018

(54) INDUCTOR AND WIRELESS POWER TRANSMISSION DEVICE

(71) Applicant: KABUSHIKI KAISHA TOSHIBA, Tokyo (JP)

(72) Inventors: Tetsu SHIJO, Tokyo (JP); Kenichirou OGAWA, Kawasaki (JP); Shuichi OBAYASHI, Yokohama (JP)

(73) Assignee: KABUSHIKI KAISHA TOSHIBA, Tokyo (JP)

(21) Appl. No.: 15/702,799

(22) Filed: Sep. 13, 2017

Related U.S. Application Data
(63) Continuation of application No. PCT/JP2015/073160, filed on Aug. 18, 2015.

(51) Int. Cl. H01F 27/02; H02J 50/10; H01F 27/24; H01F 27/28

(52) U.S. Cl. CPC H01F 27/02; H01F 27/28; H02J 50/10; H01F 27/24

(57) ABSTRACT

According to one embodiment, an inductor includes a magnetic substance core, a coil, a cast case and a cast resin. The coil is wound around the magnetic substance core. The cast case has a body at least partially formed from conductive substance, stores the magnetic substance core and the coil. The cast resin that is formed from a first resin which is an insulator, is located within the cast case, covering the magnetic substance core and the coil.

### CROSS-REFERENCE TO RELATED APPLICATIONS

The present application is a Continuation of International Application No. PCT/JP2015/073160, filed on Aug. 18, 2015, the entire contents of which is hereby incorporated by reference.

### FIELD

Embodiments described herein relate generally to an inductor and a wireless power transmission device.

### BACKGROUND

To improve the strength and heat dissipation of inductors for wireless power transmission, an inductor with a magnetic substance core and a coil covered with resin have been used. Conventional inductors were produced by casting the resin into a mold where the magnetic substance core and the coil are located. After the resin hardened, the resin was released from the mold. Then, shielding material or the like was attached to the surface. Therefore, the production of conventional inductors depended on the number of the molds available for casting, making it difficult to increase production output.

### BRIEF DESCRIPTION OF THE DRAWINGS

FIG. 1 is a perspective view showing an example of an inductor according to a first embodiment.

FIG. 2 is an A-A′ line cross-sectional view of the inductor in FIG. 1.

FIG. 3 is a perspective view showing another example of the inductor according to a first embodiment.

FIG. 4 is a perspective view showing an example of an inductor according to a second embodiment.

FIG. 5 is an A-A′ line cross-sectional view of the inductor in FIG. 4.

FIG. 6 is a cross-sectional view showing an example of an inductor according to a third embodiment.

FIG. 7 is a cross-sectional view showing an example of an inductor according to a fourth embodiment.

FIG. 8 is a cross-sectional view showing an example of an inductor according to a fifth embodiment.

FIG. 9 is a cross-sectional view showing an example of an inductor according to a sixth embodiment.

FIG. 10 is a cross-sectional view showing an example of an inductor according to a seventh embodiment.

FIG. 11 is a cross-sectional view showing another example of the inductor according to the seventh embodiment.

FIG. 12 is a perspective view showing an example of an inductor according to an eighth embodiment.

FIG. 13 is an A-A′ line cross-sectional view of the inductor in FIG. 12.

FIG. 14 is a cross-sectional view showing another example of the inductor according to the eighth embodiment.

FIG. 15 is a perspective view showing an example of an inductor according to a ninth embodiment.

FIG. 16 is a cross-sectional view showing an example of an inductor according to a tenth embodiment.

FIG. 17 is a perspective view showing an example of an inductor according to an eleventh embodiment.

FIG. 18 is a plan view of the inductor in FIG. 17.

FIG. 19 is an A-A′ line cross-sectional view of the inductor in FIG. 17.

FIG. 20 is a plan view showing another example of the inductor according to the eleventh embodiment.

FIG. 21 is a block diagram showing a schematic configuration of a power receiving device according to a twelfth embodiment.

FIG. 22 is a block diagram showing a schematic configuration of a power supplying device according to the twelfth embodiment.

### DETAILED DESCRIPTION

According to one embodiment, an inductor includes a magnetic substance core, a coil, a cast case and a cast resin. The coil is wound around the magnetic substance core or wound on a surface of the magnetic substance core. The cast case has a body at least partially formed from conductive substance, stores the magnetic substance core and the coil therein. The cast resin is formed from a first resin which is an insulator, is located within the cast case, covering the magnetic substance core and the coil.

Below, the embodiment of the present invention is described in detail with reference to the drawings.

Hereinafter, embodiments of the present invention will be described with reference to the drawings.

### First Embodiment

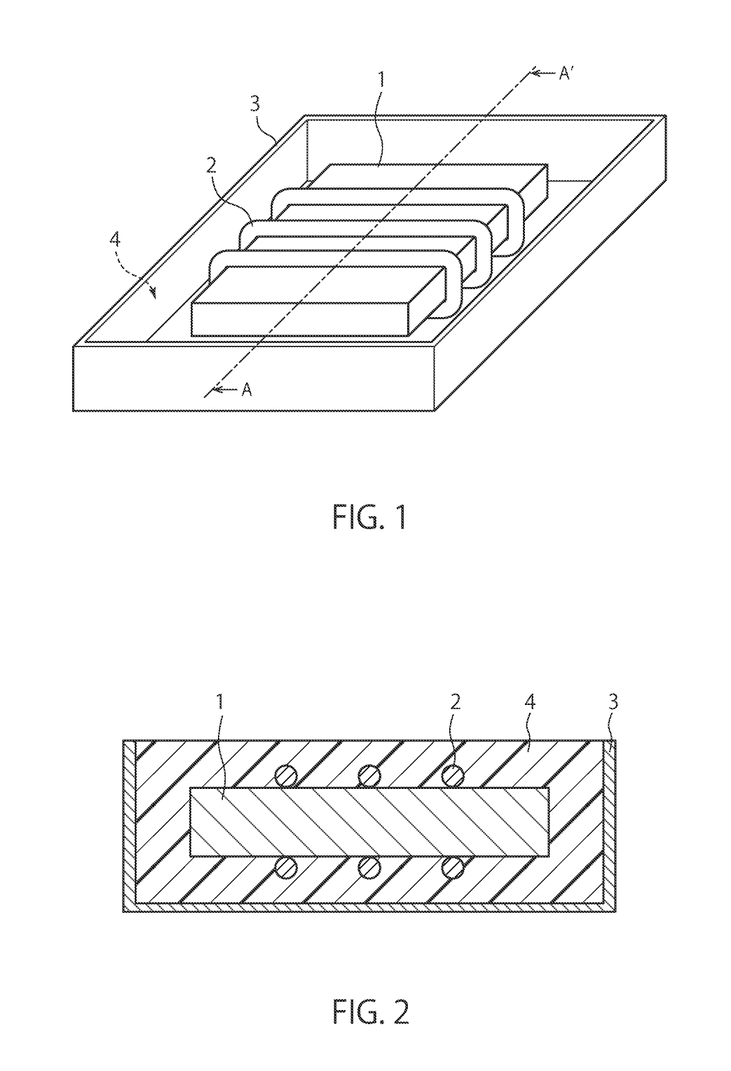

An inductor according to a first embodiment will be described with reference to FIG. 1 to FIG. 3. The inductor according to the embodiment can be used as a power supplying pad and a power receiving pad for wireless power transmission.

FIG. 1 is a perspective view showing an example of the inductor according to the embodiment. FIG. 2 is an A-A′ line cross-sectional view of the inductor in FIG. 1. As shown in FIG. 1 and FIG. 2, the inductor includes a magnetic substance core 1, a coil (winding) 2, a cast case 3 and a cast resin 4. In FIG. 1, the cast resin 4 is illustrated transparently. Despite FIG. 1, cast resin 4 does not necessary need to be optically transparent.

The magnetic substance core 1 is formed from magnetic substances such as ferrite or magnetic steel sheets or the like. In FIG. 1, the magnetic substance core 1 is formed into a tabular shape, but it can be formed to other shapes. The inductor may include a single magnetic substance core 1 as shown in FIG. 1, or may include a plurality of magnetic substance cores.

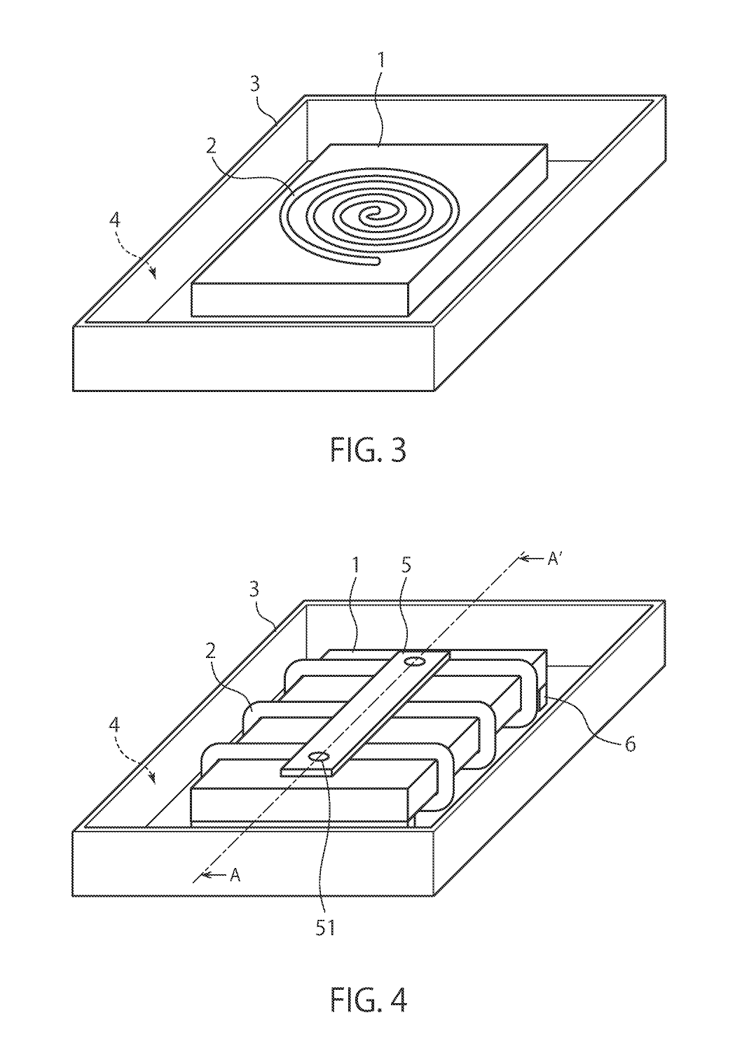

The coil 2 is wound around the magnetic substance core 1. To form coil 2, a copper wire, an aluminum wire, a conductor plate, a litz wire or the like can be used. Electric current flows through the coil 2, so that the inductor can generate a magnetic field. In the example of FIG. 1, the coil 2 is wound helically around the magnetic substance core 1, forming a solenoidal coil. However, as shown in FIG. 3, the coil 2 may be wound spirally on the surface of the magnetic substance core 1, to form a planar coil.

The cast case 3 is the housing of the inductor, and stores the magnetic substance core 1 and the coil 2 inside. As shown in FIG. 1, the cast case 3 has a bottom surface and walls on each of the four sides. In the cast case 3, the roof (located in the opposite side of the bottom surface) is opened, and the magnetic substance core 1 and the coil 2 are both inserted from the opened roof. At least a part of the cast case 3 is made from conductive substance. Metals such as aluminum, copper or the like can be used as the conductive substance.

The cast resin 4 is located inside of the cast case 3, and covers the magnetic substance core 1 and coil 2, inserted into the cast case 3. The cast resin 4 is formed by casting the first resin that is an insulator into the cast case 3 from the roof, after both the magnetic substance core 1 and the coil 2 are placed in cast case 3. The cast case 3 is used as a mold for casting the first resin to form cast resin 4. As shown in FIG. 2, since coil 2 is covered with cast resin 4 which is an insulator, the coil 2 and the conductive part of the cast case 3 are insulated. For the first resin, a thermosetting resin such as epoxy, a normal-temperature setting resin or the like can be used

As described above, in the inductor according to the embodiment, the cast case 3 becomes the mold for forming the cast resin 4. Thus, a separate mold to form the cast resin 4 is not required. Therefore, it is possible to produce a plurality of inductors, regardless of the number of molds available for casting. According to the embodiment, it is possible to make the manufacturing process of the inductor simpler and faster. Since the steps that include the releasing of the cast resin 4 from the mold and the attachment of shielding material are no longer needed, production will become easier.

Furthermore, since at least a part of the cast case 3 is formed from conductive substances, it is possible to improve the heat dissipation and mechanical strength of the inductor. Also, magnetic coupling between other inductors will become stronger. This is because the conductive part of the cast case 3 shields the leaking electromagnetic field from the inductor.

To get the highest heat dissipation, the greatest mechanical strength and strongest magnetic coupling, it is preferable that the whole cast case 3 be made from conductive substances. If such an inductor is used as a power supplying pad or power receiving pad of a wireless power transmission device, power is transmitted to the direction where the cast case 3 is opened. (the upper direction in FIG. 1) In the same direction, the cast resin 4 is exposed to the exterior of the cast case 3.

### Second Embodiment

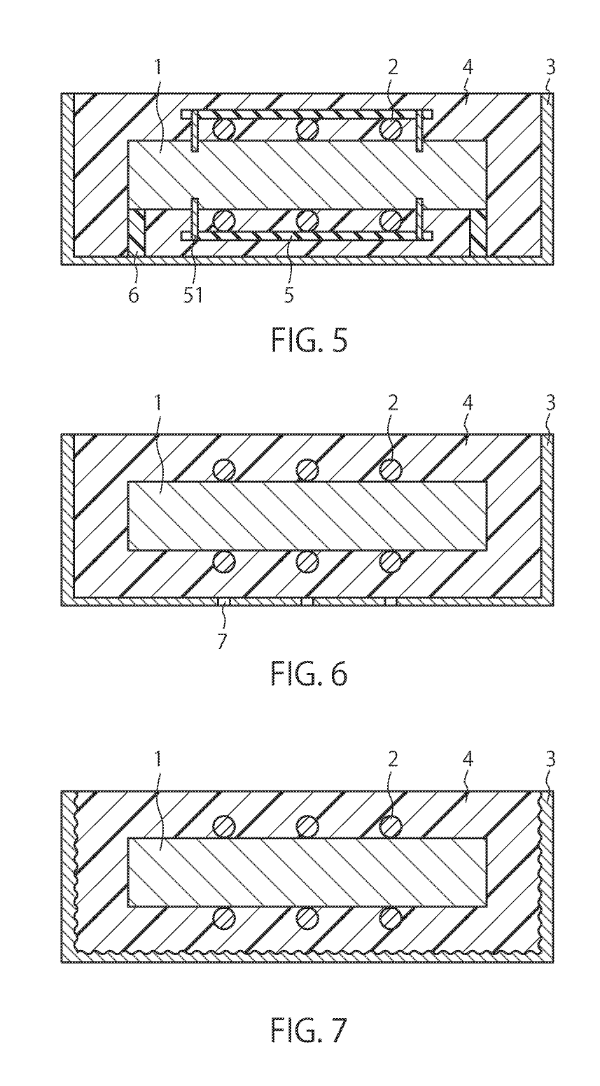

An inductor according to a second embodiment will be described with reference to FIG. 4 and FIG. 5. FIG. 4 is a perspective view showing an example of an inductor according to the embodiment. FIG. 5 is an A-A′ line cross-sectional view of the inductor in FIG. 4. As shown in FIG. 4 and FIG. 5, the inductor includes a coil supporting member 5 and a magnetic substance core supporting member 6. The rest is the same as the first embodiment.

The coil supporting member 5 is an insulator that fixes the coil 2 to the magnetic substance core 1. The coil supporting member 5 is located on the coil 2, and is fixed to the magnetic substance core 1. The coil supporting member 5 may be formed from the first resin, or may be formed from some other insulating substance.

In FIG. 4 and FIG. 5, the coil supporting member 5 is located on both sides of the tabular-shaped magnetic substance core 1. Both edges of the supporting member 5 are attached to the magnetic substance core 1 by screws 51. However, a variety of other forms are also possible. For example, there can be a coil supporting member 5 only in one side of the magnetic substance core 1. A plurality of coil supporting members 5 can be located in either or both sides of the magnetic substance core 1. The coil supporting member 5 can be bar-shaped. Both edges of the supporting member 5 can be bonded to the magnetic substance core 1.

The magnetic substance core supporting member 6 is an insulator that supports the magnetic substance core 1 and keeps the coil 2 detached from the bottom surface of the cast case 3, when the first resin is casted. As shown in FIG. 5, the magnetic substance core supporting member 6 is located between the bottom surface of the cast case 3 and the magnetic substance core 1. When the magnetic substance core 1 and the coil 2 are inserted into the cast case 3, the substance core supporting member 6 positions the magnetic substance core 1 and the coil 2 so that the bottom side of the magnetic substance core 1 will face the bottom surface of cast case 3. The magnetic substance core supporting member 6 may be formed from the first resin, or may be formed from some other insulator. Furthermore, the magnetic substance core supporting member 6 may be integrated with the cast case 3, or may be independent from the cast case 3. The magnetic substance core supporting member 6 can be fixed to the cast case 3 with screws or an adhesive. The magnetic substance core supporting member 6 may be unfixed to the cast case 3. Similarly, the magnetic substance core supporting member 6 can be fixed to the bottom side of the magnetic substance core 1 with a screw or an adhesive. The magnetic substance core supporting member 6 may also be unfixed to the magnetic substance core.

In the inductor according to the embodiment, the coil supporting member 5 prevents the coil 2 from moving away from the magnetic substance core 1. Thus, it is possible to prevent the coil 2 from coming in contact with the bottom surface of the cast case 3 when the first resin is casted. To prevent undesired contact, it is preferable that at least one coil supporting member 5 be placed in the bottom side of the magnetic substance core 1.

According to the embodiment, the magnetic substance core supporting member 6 keeps some room between the coil 2 and the bottom surface of the cast case 3. Thus, it is possible to prevent the coil 2 from coming in contact with the bottom surface of the cast case 3 when the first resin is casted.

### Third Embodiment

An inductor according to a third embodiment will be described with reference to FIG. 6. FIG. 6 is a cross-sectional view showing an example of the inductor according to the embodiment. As shown in FIG. 6, in the inductor according to the embodiment, the cast case 3 has a plurality of through-holes 7. The rest is the same as the first embodiment.

The through-holes 7 are openings in the cast case 3. In FIG. 6, a plurality of through-holes 7 are in the bottom surface of the cast case 3. However, the through-holes 7 may be located in other sides, and there may be only a single through-hole. The through-holes 7 can be sealed with a conductive tape or resin. The through-holes 7 can be pierced before the casting of first resin or after the formation of cast resin 4.

After the first resin is casted into the cast case 3, the volume of first resin decreases due to cure shrinkage or thermal shrinkage. Therefore, space may occur between the formed cast resin 4 and the cast case 3. Since this space has a lower air pressure than atmospheric pressure, partial discharge occurs at a lower voltage, according to Paschen's law. As a result, the partial discharge between the coil 2 and the cast case 3 may occur relatively easily, causing failure of the inductor.

According to the embodiment, even when there is space between the cast resin 4 and the cast case 3, air can flow into the space through the through-holes 7. Then, the air pressure of the space will reach atmospheric pressure. Therefore, it is possible to reduce the possibility of partial discharge between the coil 2 and the cast case 3.

When the potential difference between both sides of the coil 2 reaches 100 Vrms or greater, it is likely that partial discharge occurs according to Paschen's law. However, according to the embodiment, even when the potential difference is 100 Vrms or greater, it is possible to reduce the possibility of partial discharge. Thus, the inductor according to the embodiment can be used in cases when the voltage between both sides of the coil 2 reaches exceeds 100 Vrms during wireless power transmission.

### Fourth Embodiment

An inductor according to a fourth embodiment will be described with reference to FIG. 7. FIG. 7 is a cross-sectional view showing an example of the inductor according the embodiment. As shown in FIG. 7, in the embodiment, the internal surface of the cast case 3 is roughened. The rest is the same as the first embodiment.

One way to roughen the surface is blasting but other methods can be employed. In the example of FIG. 7, the whole surface within the interior of the cast case 3 is roughened. Alternatively, only a part of the surface within the interior of the cast case 3 can be roughened.

By roughening the surface within the interior of the cast case 3, it is possible to make the cast resin 4 attached to the cast case 3 firmly, reducing the possibility of the cast resin 4 being separated from the cast case 3 due to shrinkage. The possibility of partial discharge between the coil 2 and the cast case 3 will also be reduced.

### Fifth Embodiment

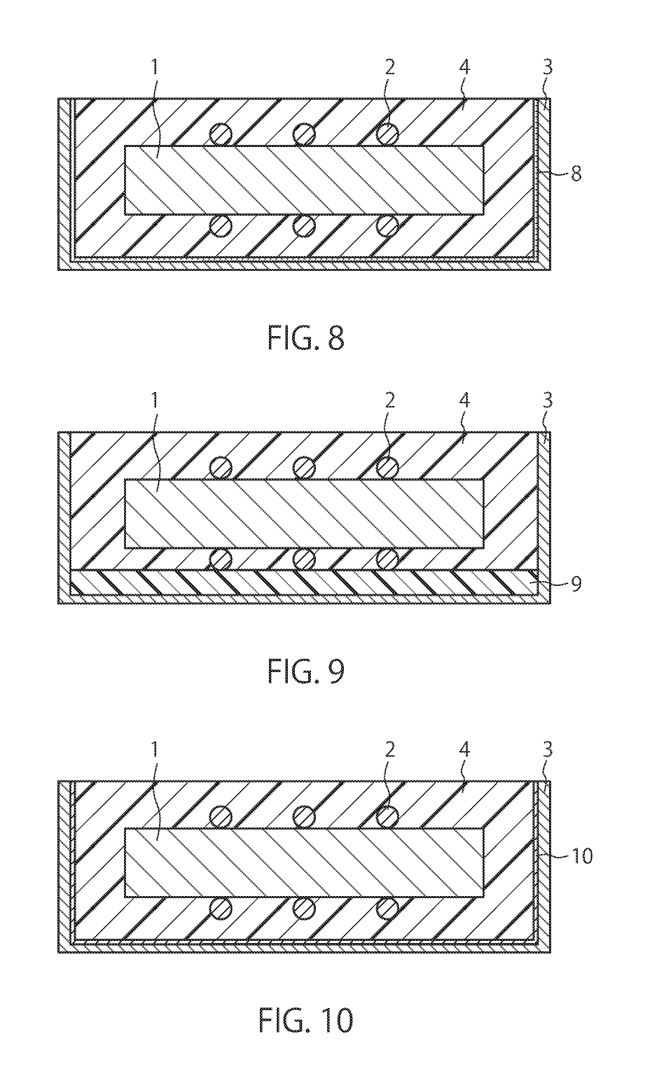

An inductor according to a fifth embodiment will be described with reference to FIG. 8. FIG. 8 is a cross-sectional view showing an example of the inductor according to the embodiment. As shown in FIG. 8, the inductor according to the embodiment includes a primer layer 8. The rest is the same as the first embodiment.

The primer layer 8 is located between the cast case 3 and the cast resin 4. The primer layer 8 is formed by coating the surface within the interior of the cast case 3 with a primer. After the surface within the interior of the cast case 3 is coated with primer, the first resin is casted. The primer layer 8 is formed on the whole surface within the interior of the cast case 3 in FIG. 8, but only a part of the surface may be coated. For the primer used to form the primer layer 8, an epoxy resin adhesive or the like can be used.

By forming the primer layer 8 on the surface within the interior of the cast case 3, it is possible to improve the bonding between the inner surface of the cast case 3 and the cast resin 4, reducing the possibility of the cast resin 4 being separated from the cast case 3 due to shrinkage. It is also possible to reduce the possibility of partial discharge between the coil 2 and the cast case 3.

### Sixth Embodiment

An inductor according to a sixth embodiment will be described with reference to FIG. 9. FIG. 9 is a cross-sectional view showing an example of the inductor according to the embodiment. As shown in FIG. 9, the inductor according to the embodiment includes a ground layer 9. The rest is the same as the first embodiment.

The ground layer 9 is formed between the bottom surface of the cast case 3 and the magnetic substance core 1 with the coil 2, covering the bottom surface of the cast case 3. The ground layer 9 is formed from a second resin that is an insulator. First, the second resin is casted into the cast case 3 to form the ground layer 9. Then, the magnetic substance core 1 and the coil 2 are placed on the ground layer 9. Finally, a first resin which is an insulator is casted. Thus, the cast case 3 is used as a mold for the casting of the second resin and for the formation of the ground layer 9.

The second resin can be made from the same formula as the first resin. If the second resin is made from the same formula as the first resin, it is possible to reduce the possibility of the ground layer 9 being separated from the cast resin 4 due to shrinkage.

The second resin can be made from a different formula from the first resin. For example, a resin with a high thermal conductivity can be used as the first resin, and a resin with a high mechanical strength can be used as the second resin. Thereby, it is possible to improve the heat dissipation and mechanical strength of the inductor.

Further, resin with a low viscosity can be used as the first resin, and resin with a high mechanical strength and a high insulating capacity can be used as the second resin. Thereby, it is possible to make production of the inductor easier while maintaining the mechanical strength and the insulating capacity.

By forming the ground layer 9 before the formation of the cast resin 4, it is possible to keep the coil 2 away from the bottom surface of the cast case 3. Thus, it is possible to prevent the coil 2 from coming in contact with the bottom surface of the cast case 3 when the first resin is casted.

### Seventh Embodiment

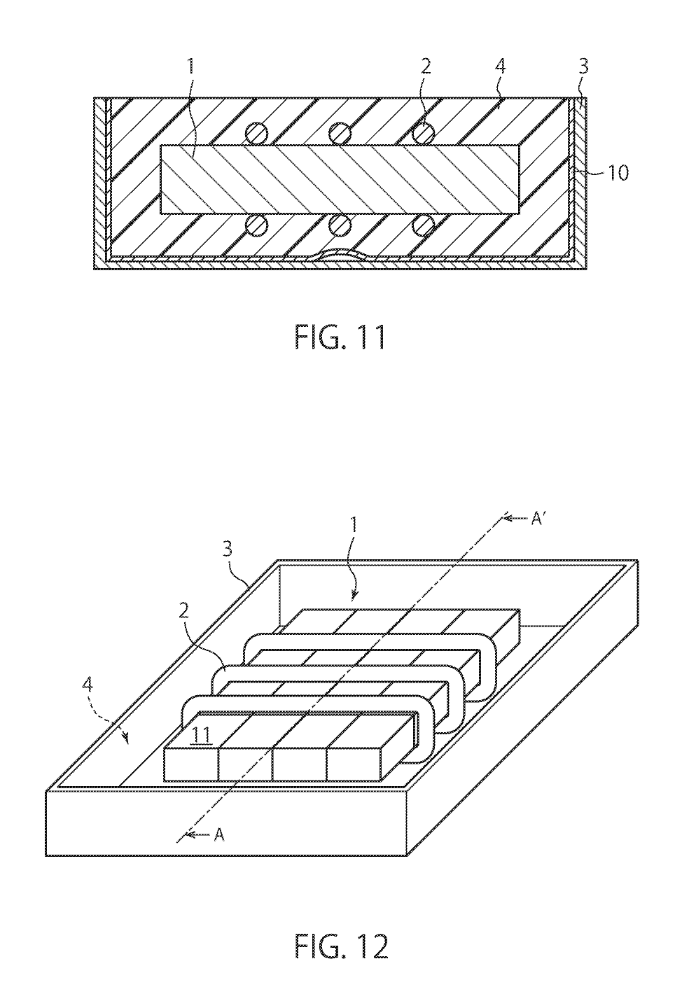

An inductor according to a seventh embodiment will be described with reference to FIG. 10 and FIG. 11. FIG. 10 is a cross-sectional view showing an example of the inductor according to the embodiment. As shown in FIG. 10, the inductor according to the embodiment includes a semiconductive layer 10. The rest is the same as the first embodiment.

The semiconductive layer 10 is located between the cast case 3 and the cast resin 4. The semiconductive layer 10 is formed by coating the surface within the interior of the cast case with a semiconductive substance. The semiconductive substance herein is a material that has a higher electric conductivity compared to insulators but has a lower electric conductivity compared to conductors. Thus, the semiconductive substance has higher conductance compared to the first resin. Typically, semiconductive substances are materials that have an electric conductivity between 10⁻⁶ S/m and 10⁶ S/m. The semiconductive substance can be formed from a mixture of insulators and conductors such as carbon, silver paste or the like.

In the embodiment, after the surface within the interior of the cast case 3 is coated with the semiconductive substance, the first resin is casted. In FIG. 10, the semiconductive layer 10 is formed on the whole surface within the interior of the cast case 3. However, the semiconductive layer 10 can be formed on only a part of the surface.

In the embodiment, when the shrinkage of the first resin occurs and space is formed between the cast case 3 and the cast resin 4, the semiconductive layer 10 covers the surface of the cast resin 4 as shown in FIG. 11. Since the cast case 3 and the semiconductive layer 10 have the same electric potential, there will be no potential difference between the spaced cast case 3 and the cast resin 4. Thus, according to the embodiment, it is possible to reduce the possibility of partial discharge between the cast case 3 and the cast resin 4.

In the case when the voltage between both edges of the coil 2 is 100 Vrms or greater, partial discharge may occur easily according to Paschen's law. According to the embodiment, even in the case when the potential difference exceeds 100 Vrms, it is possible to reduce the possibility of partial discharge. Thus, the inductor according to the embodiment can be used, even in cases when the voltage between both edges of the coil 2 exceeds 100 Vrms during wireless power transmission.

Here, instead of the semiconductive layer 10, a conductive layer can be formed between the cast case 3 and the cast resin 4. The same effect can be achieved with the conductive layer. For example, the conductive layer can be formed from a thin conductor plate (conductor foil). It is preferable that the conductor plate is thinner than the cast case 3. When the cast resin 4 comes separated from the cast case 3 due to shrinkage, the conductor plate can bend or stretch to keep the surface of cast resin 4 covered.

### Eighth Embodiment

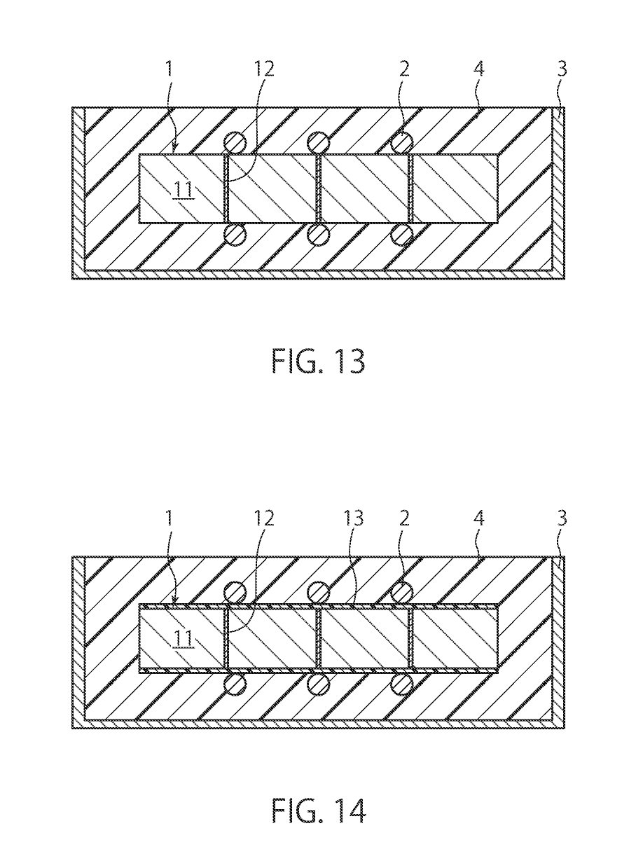

An inductor according to an eighth embodiment will be described with reference to FIG. 12 to FIG. 14. FIG. 12 is a cross-sectional view showing an example of the inductor according to the embodiment. FIG. 13 is an A-A′ line cross-sectional view of the inductor in FIG. 12. In FIG. 12, the cast resin 4 is illustrated transparently. Despite FIG. 12, the cast resin 4 does not necessary need to be optically transparent. As shown in FIG. 12 and FIG. 13, the inductor according to the embodiment, has a magnetic substance core 1 that is formed from a plurality of magnetic substance pieces 11. The rest is the same as the first embodiment.

The magnetic substance core 1 is formed from a plurality of magnetic substance pieces 11 that are flat plate-shaped. Each magnetic substance piece 11 is formed from ferrite, a powder magnetic core, a magnetic steel sheet or the like. As shown in FIG. 13, the magnetic substance pieces 11 are attached with a binder 12.

The binder 12 can be a fluent substance containing some magnetic material. For the magnetic material, magnetic substances that are powdered or in particle form can be used. For the fluent substance, an adhesive composed of a resin material such as epoxy resin, silicone or the like can be used. For example, the binder 12 can be an adhesive filled with ferrite powder.

In the embodiment, the magnetic substance core 1 is formed by coating the sides of the plurality of magnetic substance pieces 11 with binder 12. Then, the magnetic substance pieces 11 are pressed together for a certain period. Thereby, it is possible to prevent the formation of a region (an air gap or the like) with a low relative permeability between the magnetic substance pieces 11. Thus, it is possible to reduce the regional concentration of magnetic fluxes and core loss within the magnetic substance core 1.

The magnetic substance core 1 is formed from discrete magnetic substance pieces 11 to avoid some technical difficulties in manufacturing process. When the inductor is used for wireless power transmission, the size of the required magnetic substance core 1 depends on the transmitted power and the distance. For example, in a case when power is transmitted to a location of distance 10 cm, a magnetic substance core 1 with a width of few decimeters is required. However, if the magnetic substance core 1 is formed from ferrite, powder magnetic core or the like, it is difficult to produce a magnetic substance core 1 of such a large size due to technical factors in molding and annealing processes.

Hence, in the embodiment, the magnetic substance core 1 is formed by binding the plurality of magnetic substance pieces 11 together. Thereby, the large-size magnetic substance core 1 can be produced easily. Such an inductor can be used for wireless power transmission.

In the embodiment, a resin material having no adhesibility or having low adhesibility may be used as the fluent substance of the binder 12. The binder 12 may be composed of ferrite powder. In these cases, to bind the magnetic substance pieces 11 together, a sheet 13 can be attached to the top side and the bottom side of the magnetic substance core 1, as shown in FIG. 14.

The sheet 13 can be a polyimide film, a silicon sheet, an acrylic sheet, a glass cloth or the like. The sheet 13 can be attached to the magnetic substance core 1 by resin material such as unsaturated polyester. In FIG. 14, the sheet 13 is attached to both sides of the magnetic substance core 1. However, the sheet 13 may be attached to only one side.

### Ninth Embodiment

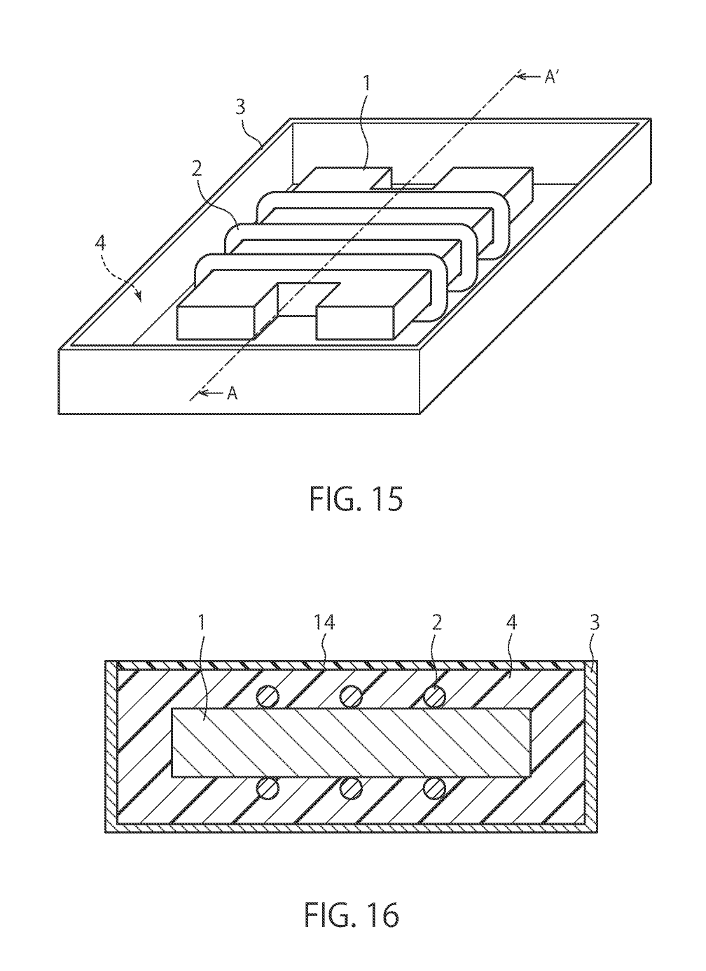

An inductor according to a ninth embodiment will be described with reference to FIG. 15. FIG. 15 is a perspective view showing an example of the inductor according to the embodiment. In FIG. 15, the cast resin 4 is illustrated transparently. Despite FIG. 15, the cast resin 4 does not necessary need to be optically transparent. As shown in FIG. 15, the magnetic substance core 1 is shaped so that the cross-sectional area viewed from the magnetic flux direction (the direction of A-A′ line in FIG. 15) in the vicinity of the coil 2 is greater than the cross-sectional area of other sections. The rest is the same as the first embodiment.

The section in the vicinity of the coil 2 is the part of the magnetic substance core 1 that it is surrounded by the coil 2. The section in the vicinity of the coil 2 is also the section where the magnetic flux density is the highest in the magnetic substance core 1. By increasing the cross-sectional area of this section, it is possible to reduce the magnetic flux density in the magnetic substance core 1.

For inductors that have a magnetic substance core 1, some core loss occurs. The core loss is the loss of energy within the magnetic substance core 1. Core loss includes hysteresis loss and eddy current loss. Core loss will increase if the magnetic flux density within the magnetic substance core 1 increases. Core loss can be reduced by making a part of the magnetic substance core 1 wider, thereby decreasing the magnetic flux density within the magnetic substance core 1.

### Tenth Embodiment

An inductor according a tenth embodiment will be described with reference to FIG. 16. FIG. 16 is a cross-sectional view showing an example of the inductor according to the embodiment. As shown in FIG. 16, the inductor according to the embodiment includes a reinforcing layer 14. The rest is the same as the first embodiment.

The reinforcing layer 14, which has a higher elastic modulus compared to the cast resin 4, covers the area above the magnetic substance core 1 and the coil 2. The reinforcing layer 14 can be formed by casting resin with a higher elastic modulus compared to the first resin after the casting of cast resin 4. Another way to form reinforcing layer 14 is by placing fiber such as a glass fiber cloth above the magnetic substance core 1 and the coil 2 and then casting the first resin. Thus, the reinforcing layer 14 with fiber-reinforced plastic (FRP) structure can be formed.

With this configuration, it is possible to improve the load bearing of the inductor in the height direction (the vertical direction in FIG. 16).

### Eleventh Embodiment

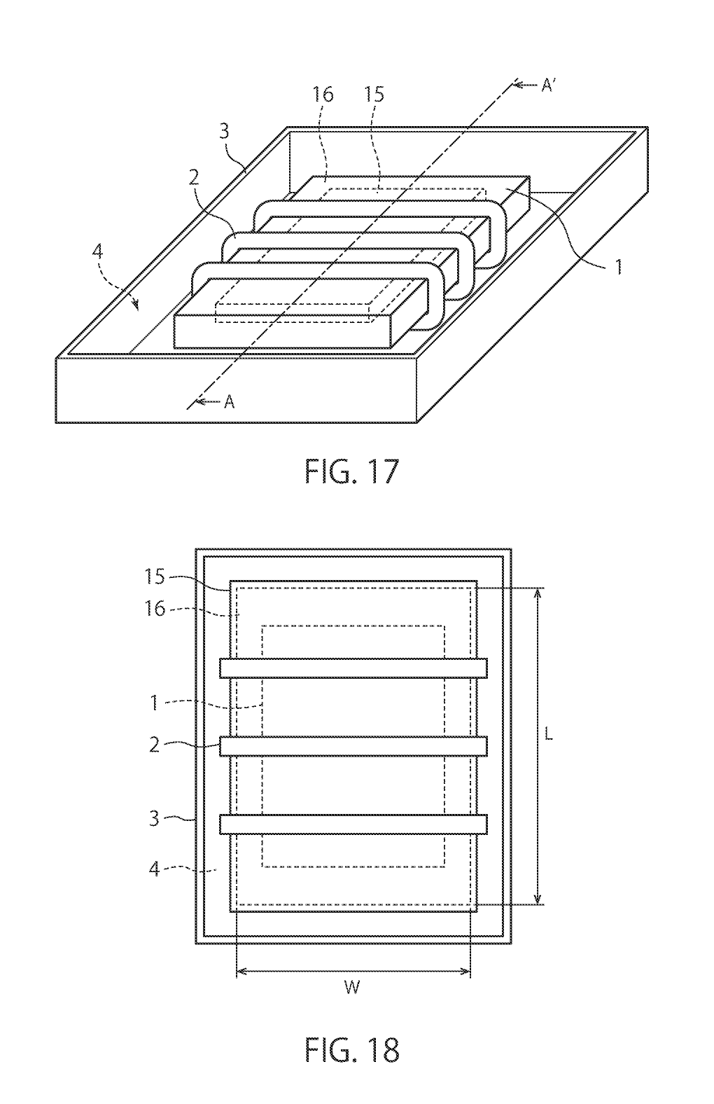

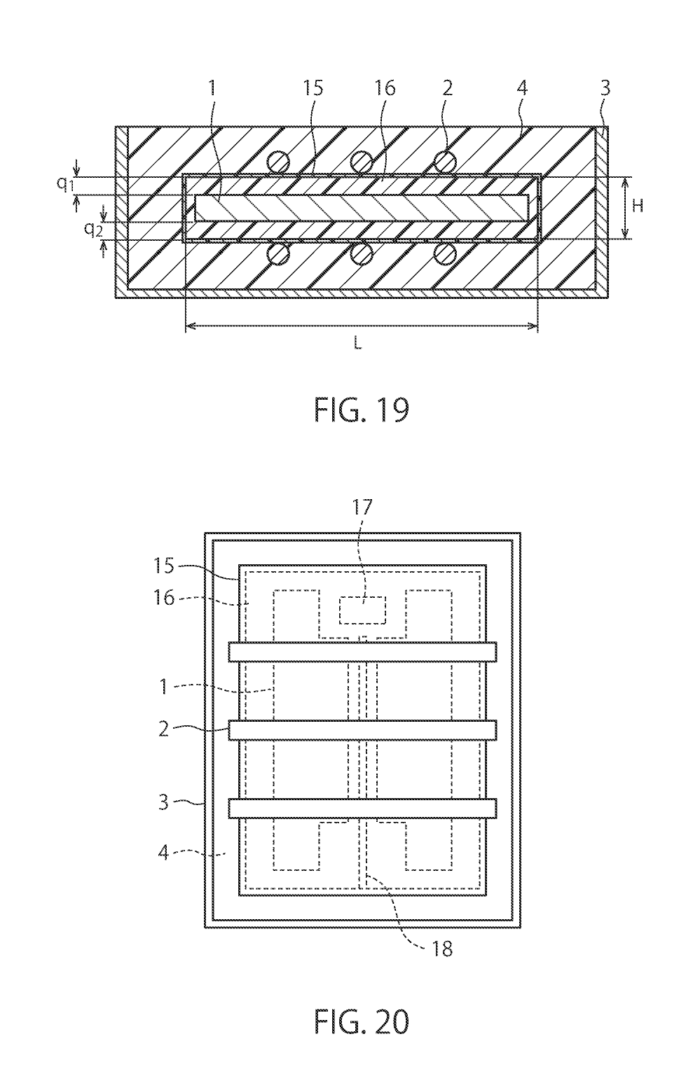

An inductor according to an eleventh embodiment will be described with reference to FIG. 17 to FIG. 20. FIG. 17 is a perspective view showing an example of the inductor according to the embodiment. FIG. 18 is a plan view of the inductor in FIG. 17. FIG. 19 is an A-A′ line cross-sectional view of the inductor in FIG. 17. In FIG. 17 and FIG. 18, the cast resin 4 is illustrated transparently. Despite FIG. 17 and FIG. 18, the cast resin 4 does not necessary need to be optically transparent. As shown in FIG. 17 to FIG. 19, the inductor according to the embodiment includes a core case 15 and a cushion material 16. The rest is the same as the first embodiment.

The core case 15 is formed from a third resin that is an insulator, and stores the magnetic substance core 1 inside. In the embodiment, the coil 2 is wound around the core case 15. As shown in FIG. 17, in the case where the coil 2 forms a solenoidal coil, the coil 2 is wound helically around the core case 15. The core case 15 acts as the bobbin for winding the coil 2. The cast resin 4 covers the exterior of the core case 15.

The inductor according to the embodiment can be formed with the following procedure. First, the magnetic substance core 1 is placed in the core case 15. Then, coil 2 is wound around the core case 15. Next, the magnetic substance core 1, the coil 2 and the core case 15 are inserted into the cast case 3. Finally, the first resin is casted into the cast case 3.

In the embodiment, the first resin is casted outside of the core case 15. So the first resin is not in direct contact with the magnetic substance core 1. Therefore, the magnetic substance core 1 is protected from stress due to cure shrinkage or thermal shrinkage of the first resin. Thus, according to the embodiment, it is possible to reduce the overall stress applied to the magnetic substance core 1 during the manufacture of the inductor.

If the first resin intrudes into the core case 15 during the formation of the cast resin 4, there is a concern that thermal stress is applied to the magnetic substance core 1. Preferably, the core case 15 is sealed before the formation of the cast resin 4, avoiding the intrusion of the first resin.

For the third resin, a thermosetting resin such as epoxy resin or the like can be used. A thermoplastic resin such as polypropylene, ABS resin, polyethylene or the like can be used as well. Other material such as glass or the like can be used. The core case 3 can be formed using casting, injection molding or laminate shaping methods with 3D printers or the like.

The third resin can be made from the same formula as the first resin. If the third resin is made from the same formula as the first resin, it is possible to reduce the possibility of the cast resin 4 being separated from the core case 15 due to shrinkage.

The third resin can be made from a different formula from the first resin. For example, resin with a high thermal conductivity can be used as the first resin, and resin with a high mechanical strength can be used as the third resin. Thereby, it is possible to improve the heat dissipation and mechanical strength of the inductor.

Furthermore, resin with a low viscosity can be used as the first resin, and resin with a high mechanical strength and a high insulation property can be used as the third resin. Thereby, it is possible to make production of the inductor easier while maintaining the mechanical strength and the insulation capacity.

The cushion material 16 is located between the magnetic substance core 1 and the core case 15, covering at least a part of the magnetic substance core 1. The cushion material 16 fixes the magnetic substance core 1 to the interior of the core case 15. The cushion material 16 will reduce the external stress applied to the magnetic substance core 1.

The cushion material 16 can be foamable resin, gum resin, gel-type resin, non-woven fabric, synthetic resin such as acrylic rubber and silicone rubber, or the like. The cushion material 16 can also be formed from semiconductive material. Thereby, there will be less concentration of electric field within the magnetic substance core 1, reducing the possibility of partial discharge between the magnetic substance core 1 and the coil 2.

To moderate the stress due to the shrinking of the first resin, it is preferable that the buffer material 16 be formed from a material with a lower elastic modulus compared to the first resin. Also, to moderate the stress due to the thermal shrinkage of the core case 15, it is preferable that the buffer material 16 be formed from a material having a lower elastic modulus compared to the third resin.

The physical configuration of the magnetic substance core 1 and the core case 15 will be described below.

Hereinafter, the internal dimension of the core case 15 to the length direction is represented as “L”, the internal dimension to the width direction is represented as “W”, and the internal dimension to the height direction is represented as “H”. The internal dimension of the core case 15 indicates the distance between the internal faces of the core case 2 in each direction. The “L”, “W” and “H” above are the internal dimensions of the core case 2 when electric current is not flowing in the coil 2. Furthermore, the dimension of the magnetic substance core 1 to the length direction is represented as “l”, the dimension to the width direction is represented as “w”, and the dimension to the height direction is represented as “h”.

The magnetic substance core 1 and the core case 15 are designed so that the minimum difference between the dimension “p” of the magnetic substance core 1 and the internal dimension “P” of the core case 15 is greater than the variation “ΔP” of the internal dimension of the core case 15 to the length direction (min(P−p)>ΔP).

For example, focusing on the length direction, the magnetic substance core 1 and the core case 15 are designed so that the minimum difference between the internal dimension “L” of the core case 15 to the length direction and the dimension “l” of the magnetic substance core 1 to the length direction is greater than the variation “ΔL” of the internal dimension of the core case 15 to the length direction.

The variation “ΔP” in the internal dimension of the core case 15 indicates the maximum range of thermal shrinkage for the core case 2 during the production of the inductor. Examples of thermal shrinkage during production of the inductor include the thermal shrinkage of the thermosetting resin when it is cooled from the setting temperature (85 degrees Celsius to 150 degrees Celsius) and the thermoplastic resin when it is cooled from the injection molding temperature (180 degrees Celsius or higher). If the minimum internal dimension of the core case 15 that shrinks is abbreviated as “P_{MIN}”, the variation can be presented as “ΔP=P−P_{MIN}.”

The variation “ΔP” is the product of three factors. One is the linear expansion coefficient α (%/° C.) of core case 15. The second is the internal dimension “P” of core case 15. The third is the variation “ΔT” (° C.) of temperature. Thus, the relationship can be presented as “ΔP=αPΔT”. The variation “ΔT” of temperature is the maximum variation of the temperature of the core case 15 during the production of the inductor.

When the temperature of the case 2 at the lowest operating temperature of the inductor is represented as “T” and the maximum temperature of the case 2 during the production of the inductor is represented as “T_{MAX}”, the variation of temperature can be presented as “ΔT=T_{MAX}−T”. The temperature “T” of the core case 15 will depend on the installation environment. For example, if the operating temperature of the electronic vehicle where the inductor is mounted is between −10 degrees Celsius and 40 degrees Celsius, “T” is −10 degrees Celsius.

Thus, the magnetic substance core 1 and the core case 15 are designed so that the relationship “min(P−p)>αPΔT” holds for each direction. For each direction, the following expressions hold respectively.

Length direction: L−l>αLΔT

Width direction: W−w>αWΔT

Height direction: H−h>αHΔT

For example, if “α=0.01%/° C.”, “L=100 mm” and “ΔT=100° C.”, relation respect to the length of the magnetic substance core 1, “l<99 mm” holds.

By designing the magnetic substance core 1 and the core case 15 with the method above, it is possible to prevent the stress due to the thermal shrinkage of the core case 15 being applied directly to the magnetic substance core 1.

Since the cushion material 16 is located between the magnetic substance core 1 and the core case 15, the total thickness “Q” will be equal to the difference between the internal dimension “P” of the core case 15 and the dimension “p” of the magnetic substance core 1 (Q=P−p).

The total thickness “Q” is the sum of thickness of the cushion material 16 located on one side of the magnetic substance core 1 and thickness of the cushion material 16 located on the other side of the magnetic substance core 1. For example, as shown in FIG. 19, when the thickness of a cushion material 16 located on the upper side of the magnetic substance core 1 is represented as “q₁” and the thickness of a cushion material 16 located on the lower side of the magnetic substance core 1 is represented as “q₂”, the total thickness “Q” of the cushion material 16 to the height direction is “Q=q₁+q₂”.

FIG. 20 is a plan view showing another example of the inductor according to the embodiment. In FIG. 20, the cast resin 4 is illustrated transparently. Despite FIG. 20, the cast resin 4 does not necessary need to be optically transparent. In FIG. 20, the core case 15 contains two magnetic substance cores 1. The two magnetic substance cores 1 are shaped so that there is a wider section and a narrower section. In the narrower section of the magnetic substance cores 1, capacitors 17 for resonance are located. A strengthening member 18 that supports the core case 15 to the height direction is located in the interior of the core case 15.

The core case 15 can store a plurality of magnetic substance cores 1 and store components other than the magnetic substance core 1 including a capacitor 17, a diode for rectification, or the like. The core case 15 can have a strengthening member 18. With the strengthening member 18, it is possible to improve the load bearing of the inductor in the height direction.

Furthermore, the inductor according to the embodiment can include a plurality of core cases 15 that contain a single or a plurality of magnetic substance cores 1. If there is a plurality of core cases 15, the coil 2 can be wound around the whole set of a plurality of core cases 15.

### Twelfth Embodiment

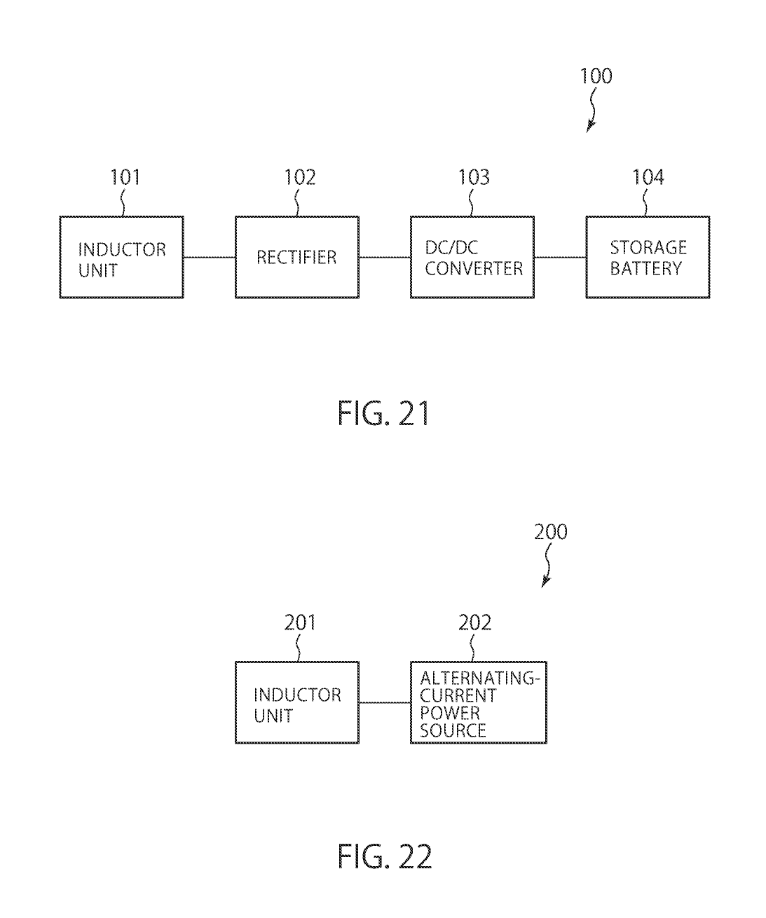

A wireless power transmission device according to a twelfth embodiment will be described with reference to FIG. 21 and FIG. 22. The wireless power transmission device according to the embodiment includes the inductor according to the first embodiment. The wireless power transmission device includes a power receiving device and a power supplying device for wireless power transmission. Below, each of the power receiving device and the power supplying device will be described.

FIG. 21 is a block diagram showing the configuration of a power receiving device 100 according to the embodiment. As shown in FIG. 21, the power receiving device 100 includes an inductor unit 101, a rectifier 102, a DC/DC converter 103 and a storage battery 104.

The inductor unit 101 includes a single or a plurality of inductors according to the first embodiment. In the power receiving device 100, the inductor receives power while resonating with an inductor located in the power supplier side. The received power is provided to the rectifier 102. The inductor unit 101 may include a capacitor for configuring a resonant circuit or a PFC circuit (power correcting circuit).

The rectifier 102 rectifies the alternating-current power provided from the inductor unit 101, to direct-current power. For example, the rectifier 102 can be a bridge circuit with diodes. The power rectified by the rectifier 102 is provided to the DC/DC converter 103.

The DC/DC converter 103 regulates the voltage of the power provided from the rectifier 102, so that an appropriate voltage is applied to the storage battery 104, and provides the regulated power to the storage battery 104.

The storage battery 104 stores the power provided from the DC/DC converter 103. Storage batteries such as a lead storage battery, a lithium-ion battery or the like can be used as the storage battery 104.

In the embodiment, the power receiving device 100 can adopt a configuration without the DC/DC converter 103 or the storage battery 104.

FIG. 22 is a block diagram showing the configuration of a power supplying device 200 according to the embodiment. As shown in FIG. 22, the power supplying device 200 includes an inductor unit 201 and an alternating-current power source 202.

The alternating-current power source 202 provides alternating-current power to the inductor unit 201. For example, the alternating-current power source 202 can receive power input from a commercial power source. The power supplied from the commercial power source is rectified. Then, by an inverter circuit, the rectified power is converted into alternating-current power for wireless power transmission. Thus, the alternating-current power source 202 can provide the converted alternating-current power. The alternating-current power source 202 may include an AC voltage regulator circuit, a DC voltage regulator circuit or a PFC circuit.

The inductor unit 201 includes a single or a plurality of inductors according to the first embodiment. In the power supplying device 200, the inductor generates an alternating-current magnetic field by using the power input from the alternating-current power source 202, and supplies power while resonating with the inductor located in the power receiving side.

As described above, the wireless power transmission device according to the embodiment includes an inductor according to the first embodiment. By configuring the wireless power transmission device using the inductor according to the first embodiment, it is possible to increase the overall production output of the wireless power transmission device.

Here, the wireless power transmission device according to the embodiment may include the inductor according to another embodiment, instead of the inductor according to the first embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An inductor comprising:
a magnetic substance core;
a coil that is wound around the magnetic substance core or wound on a surface of the magnetic substance core;
a cast case that has a body at least partially formed from conductive substance, storing the magnetic substance core and the coil therein; and
a cast resin that is formed from a first resin which is an insulator, is located within the cast case, covering the magnetic substance core and the coil.

2. The inductor according to claim 1,
wherein the cast resin is formed by casting the first resin into the cast case.

3. The inductor according to claim 1,
wherein a whole of the cast case is formed from conductive substance.

4. The inductor according to claim 1, comprising a coil supporting member which is an insulator, the coil supporting member being provided on the coil and fixed to the magnetic substance core.

5. The inductor according to claim 1, comprising a magnetic substance core supporting member that is an insulator and located between a bottom surface of the cast case and the magnetic substance core.

6. The inductor according to claim 1,
wherein the cast case includes at least one through-hole passing from an inner surface to an outer surface.

7. The inductor according to claim 6,
wherein a potential difference between both sides of the coil is 100 Vrms or higher.

8. The inductor according to claim 1,
wherein at least a part of an inner surface of the cast case is roughened.

9. The inductor according to claim 1, comprising a primer layer that covers at least a part of a space between the cast case and the case resin.

10. The inductor according to claim 1, comprising a ground layer that is formed from a second resin which is an insulator and located between a bottom surface of the cast case and the coil, covering the bottom surface of the cast case.

11. The inductor according to claim 1, comprising a semiconductive layer or a conductive layer that covers at least a part of a space between the cast case and the cast resin.

12. The inductor according to claim 1,
wherein the magnetic substance core is formed from a plurality of magnetic substance pieces that are located in a planar manner.

13. The inductor according to claim 1,
wherein a cross-sectional area of the magnetic core in a vicinity of the coil is larger than a cross-sectional area of other parts of the magnetic core.

14. The inductor according to claim 1, comprising a strengthened layer that has a greater elastic modulus compared to the cast resin, covering an area above the magnetic substance core and the coil.

15. The inductor according to claim 1, comprising a core case that stores the magnetic substance core,
wherein the coil is wound around the core case, and
the cast resin covers the core case and the coil.

16. The inductor according to claim 15, comprising a cushioning material located between the core case and the magnetic substance core.

17. The inductor according to claim 15,
wherein the core case stores the magnetic substance core and a capacitor.

18. The inductor according to claim 1,
wherein the coil is a solenoidal coil or a planar coil.

19. A wireless power transmission device comprising the inductor according to claim 1.
